(19) United States
(12) Patent Application Publication
(10) Pub. No.: US 2015/0253119 A1
(43) Pub. Date: Sep. 10, 2015

(54) ADHESIVE NOTE PAD

(71) Applicant: Terry Paul Jenkins, Hagerstown, MD (US)

(72) Inventor: Terry Paul Jenkins, Hagerstown, MD (US)

(21) Appl. No.: 14/306,960

(22) Filed: Jun. 17, 2014

Related U.S. Application Data
(60) Provisional application No. 61/948,419, filed on Mar. 5, 2014.

(51) Int. Cl. G01B 3/10; B32B 27/32; B32B 27/10; B32B 7/12

(52) U.S. Cl. CPC G01B 3/1084; B32B 7/12; B32B 27/32; B32B 27/10; B32B 2519/00; B32B 2255/10; G01B 2003/1094

(57) ABSTRACT

An adhesive notepad including a label is provided. The label includes a top surface, a bottom surface and a body portion in between the top surface and bottom surface. The top surface may include a writable varnish laminated coating which forms a semi-permanent writing surface. The bottom surface may include an adhesive layer formed to attach to the side of a tape measure. The body portion may be made of biaxial oriented polypropylene.

### CROSS-REFERENCE TO RELATED APPLICATION

This application claims the benefit of priority of U.S. provisional application No. 61/948,419, filed Mar. 5, 2014, the contents of which are herein incorporated by reference.

### BACKGROUND OF THE INVENTION

The present invention relates to an adhesive note pad and, more particularly, to an adhesive note pad attachable to a tape measure.

While taking measurements with a tape measure the user must write down or remember each measurement. Often times the user will write the measurements on various scrap pieces of lumber or various other materials. The material might not be optimum for writing and reading from. Alternatively, the user must remember the measurement and later recall what the measurement was. This leads to inaccurate measurements or re-measuring. Currently, other devices used to remedy the problems above are inconvenient attachments. Also, other devices may require an eraser to remove previously written measurements.

As can be seen, there is a need for an improved method and apparatus for recording measurements.

### SUMMARY OF THE INVENTION

In one aspect of the present invention, an adhesive notepad comprises: a label comprising a body portion having a top surface and a bottom surface, wherein the top surface comprises a semi-permanent writing surface, wherein the bottom surface comprises an adhesive layer formed to attach to the side of a tape measure.

In another aspect of the present invention, a method of recording measurements comprises: providing a label comprising a top surface with a semi-permanent writing surface; adhering the label to an outside surface of a tape measure so that the top surface is facing away from the tape measure; measuring an object; and writing the measurement of the object on the semi-permanent writing surface.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is a perspective view of the present invention;

FIG. 3 is a section detail view of the present invention along line 3-3 in FIG. 2;

FIG. 4 is a perspective view of the present invention demonstrating removal from wax paper;

FIG. 5 is an exploded view of the present invention demonstrating applications to a tape measure;

FIG. 6 is a perspective view demonstrating removal of exemplary writings; and

FIG. 7 is a perspective view demonstrating removal of the present invention from a tape measure.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a removable, writable, and wipeable tape measure note pad label. Installing a convenient writable label on a tape measure surface eliminates finding a writable service, reading illegible measurements, remembering the measurements, and/or re-measuring the objects already measured. The surface of the label may include a coating so that pencil lead may easily wipe off from the label by hand. Therefore, the note pad surface area can be reused.

The semi-permanent writing surface disclosed below includes a writing surface in which pencil lead and/or ink does not permanently stick. Further, the label may be semi-permanently attached to the side of a tape measure. If the coating on the note pad surface wears out, the label is easily removed and another label can be quickly reapplied.

In certain embodiments, the note pad label is thin and form fitting to the tape measure. The present invention may further use a Biaxial Oriented Polypropylene (BOPP) material with a gloss and/or writable varnish laminated coating, which creates a semi-permanent writing surface allowing a user to remove the written measurements by hand wiping off the surface without the need of an eraser.

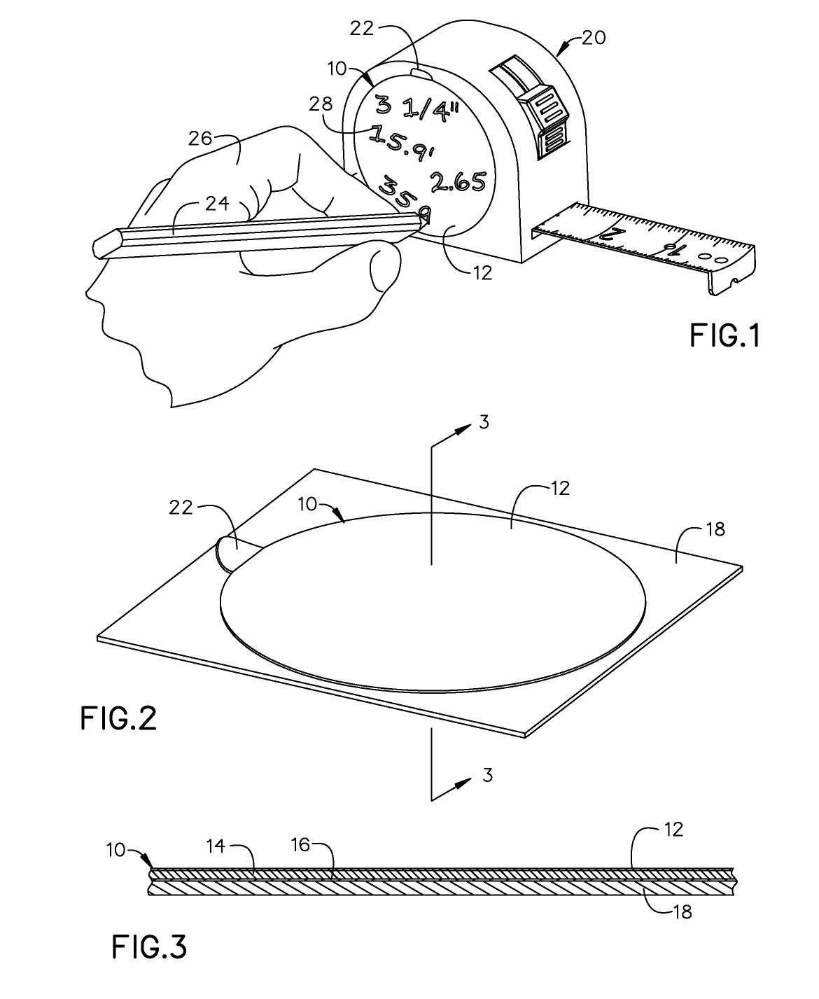

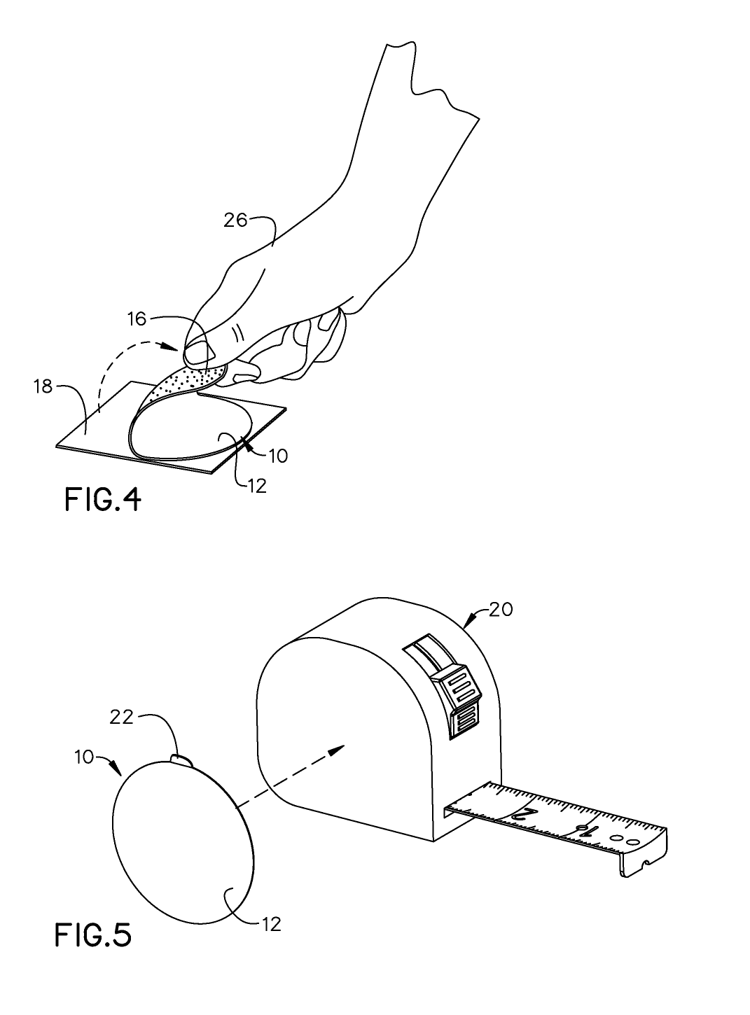

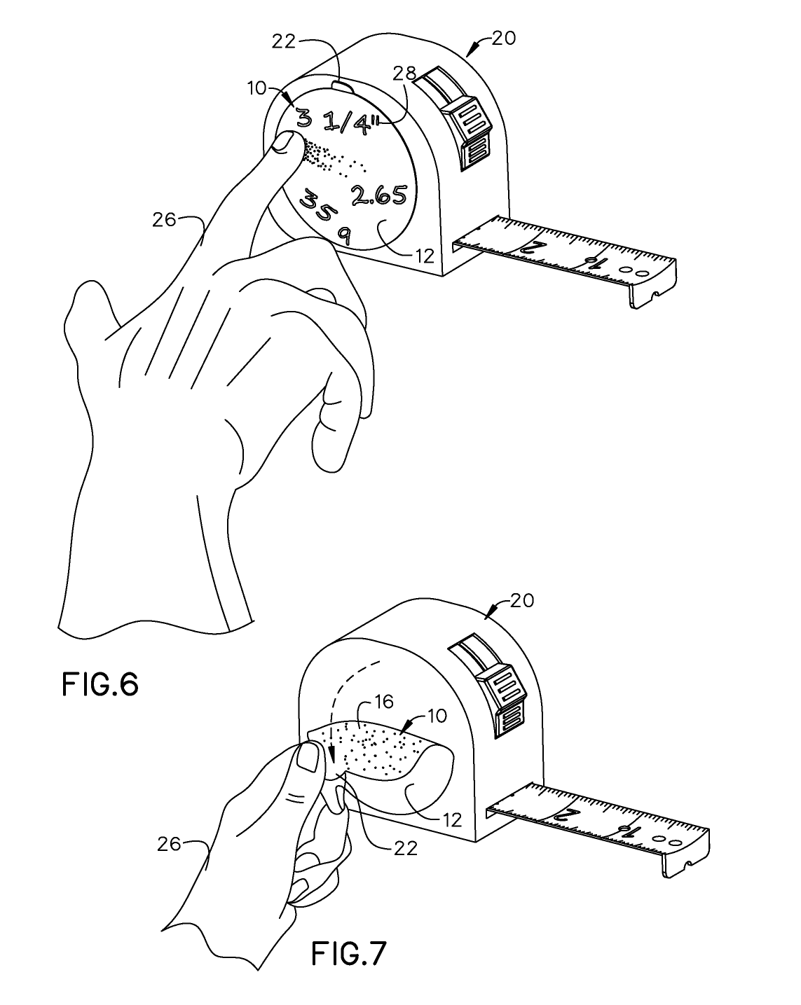

Referring to FIGS. 1 through 7, the present invention includes an adhesive notepad, such as a label 10. The label 10 includes a top surface, a bottom surface and a body portion 14 in between the top surface and bottom surface. The top surface may include a coating 12 that may be laminated which forms a semi-permanent writing surface. The bottom surface may include an adhesive layer 16 formed to attach to the side of a tape measure 20. The body portion 14 may be made of biaxial oriented polypropylene.

In certain embodiments, the label 10 is removeably attachable to the tape measure 20. Prior to placing the label 10 on the tape measure 20, a wax paper 18 may be attached to the adhesive layer 16 to preserve the adhesive. Further, the present invention may include a label pull tab 22 protruding from the parameter of the label 10. Therefore, when the user is removing the label 10 from the wax paper 18 or from the tape measure 20, the user 26 may use the pull tab 22 to grasp the label 10.

A method of recording measurements 28 may include the following: providing a label 10 having a top surface with a writable varnish laminated coating 12 forming a semi-permanent writing surface; adhering the label 10 to an outside surface of a tape measure 20 so that the top surface is facing away from the tape measure 20; measuring an object; and writing the measurement 28 of the object on the gloss laminated coating 12 with a writing utensil 24. The method may further include the steps of: wiping the written measurement off of the writable varnish laminated coating 12; removing the label 10 from the tape measure 20 and adhering a new label 10 to the tape measure 20; and removing a wax paper 18 adhered to the label 10 prior to adhering the label 10 to the tape measure 20.

The ergonomic design of the present invention eliminates bulky tape measure attachments. The surface area of the tape measure may be flat and may not impede the users writing ability while taking measurements. The naturally occurring flat side of a tape measure provides a writing surface for measurements to be written on and measurements to be recalled from. For the user, the note pad surface coating creates a writable and a hand wipeable surface measurement note taking area without having to use of an eraser.

The note pad label surface has a coating which can be written on with any pencil. The surface coating also makes the written measurements erasable by hand. Locating the note pad on the side of a tape measure increases the user convenience/accuracy by giving the user an immediate area to write down the measurements. After a measurement is taken the user can quickly write down the length on the note pad label. The user doesn't have to find another note taking material nor does the user need an eraser to remove the written measurements.

It should be understood, of course, that the foregoing relates to exemplary embodiments of the invention and that modifications may be made without departing from the spirit and scope of the invention as set forth in the following claims.

What is claimed is:

1. An adhesive notepad comprising:
a label comprising a body having a top surface and a bottom surface, wherein the top surface comprises a semi-permanent writing surface, wherein the bottom surface comprises an adhesive layer formed to attach to the side of a tape measure.

2. The adhesive notepad of claim 1, wherein the semi-permanent writing surface comprises a varnish coating.

3. The adhesive notepad of claim 1, wherein the body portion is biaxial oriented polypropylene.

4. The adhesive notepad of claim 1, further comprising a wax paper releasably attached to the adhesive material prior to use.

5. The adhesive notepad of claim 1, further comprising a label pull tab protruding from a parameter of the label.

6. The adhesive notepad of claim 1, wherein the varnish coating is laminated.

7. A method of recording measurements comprising:
providing a label comprising a top surface with a semi-permanent writing surface;
adhering the label to an outside surface of a tape measure so that the top surface is facing away from the tape measure;
measuring an object; and
writing the measurement of the object on the a semi-permanent writing surface.

8. The method of claim 7, wherein the semi-permanent writing surface comprises a varnish coating.

9. The method of claim 7, wherein the label comprises a biaxial oriented polypropylene.

10. The method of claim 7, further comprising the step of wiping the written measurement off of the semi-permanent writing surface.

11. The method of claim 7, further comprising the step of removing the label from the tape measure and adhering a new label to the tape measure.

12. The method of claim 7, further comprising the step of removing a wax paper adhered to the label prior to adhering the label to the tape measure.
